(19) United States
(12) Patent Application Publication
(10) Pub. No.: US 2018/0176221 A1
(43) Pub. Date: Jun. 21, 2018

(54) Methods and Systems for Verifying a User Login Using Contact Information of the User

(71) Applicant: FACEBOOK, INC., Menlo Park, CA (US)

(72) Inventors: Li Zhou, Mountain View, CA (US); Calvin Tsun-Lam Mak, Seattle, WA (US); Olga Ivanovna Kuznetsova, Seattle, WA (US); Todd Michael Krabach, Woodinville, WA (US); Emilia Kathleen Dallman Howley, San Francisco, CA (US); Jonathon Daniel Colman, Seattle, WA (US); Pui Ling Tsang, Issaquah, WA (US)

(21) Appl. No.: 15/387,490

(22) Filed: Dec. 21, 2016

(51) Int. Cl. H04L 29/06; G06F 21/31

(52) U.S. Cl. CPC H04L 63/0884; G06F 2221/2115; G06F 21/31

(57) ABSTRACT

A server system receives, from a first device, a request to authenticate a user with a third-party application using a social networking system and contact information of the user. The server system requests the social networking system to authenticate the user based on the contact information. The social networking system is different from the third-party application.

### TECHNICAL FIELD

This relates generally to network communications, including but not limited to verifying a user's login to an application by using contact information of the user.

### BACKGROUND

Mobile devices and applications have become an increasingly dominant means through which consumers access, download, and consume electronic content over the Internet. Many of these applications require the user to log in or otherwise authenticate with them in order to use the application or various features of the application. In some cases, the user may log in using, for example, social networking system login information or email account login information.

However, a user who wishes to use an application may question the legitimacy of that application. Because of this, for example, the user may be wary of providing the application with his or her full login information. Furthermore, even if the application provides for an alternate way to verify the login, such a form of verification may be unreliable and/or not always available. This may cause the user to decide not to use the application.

### SUMMARY

Accordingly, there is a need for methods, devices, and systems for improving user verification with various applications that run on mobile devices. Embodiments set forth herein are directed to methods, devices, and systems for verifying a user with an application using contact information of the user. For example, the user may provide his or her contact information to the application on a user device, and a separate server system may send a request for authentication to the contact information in order to confirm to the application that the user is verified. In an example where the user fails to receive this request for authentication at the contact information, the user may opt to verify with, e.g., a social networking system, which may have the contact information stored in correlation with the user's profile. By providing this alternate form of verifying with the social networking system, the user may still be able to use the application without needing to provide the application with his or her full login information, even when authentication sent to the contact information fails.

In accordance with some embodiments, a method is performed at a server system having one or more processors and memory storing instructions for execution by the one or more processors. The method includes receiving, from a first device, a request to authenticate a user with a third-party application using a social networking system and contact information of the user, and requesting the social networking system to authenticate the user based on the contact information. The social networking system is different from the third-party application.

In accordance with some embodiments, a server system has one or more processors and memory storing instructions for execution by the one or more processors. The instructions include instructions for performing the above method. In accordance with some embodiments, a non-transitory computer-readable storage medium has stored therein instructions that, when executed by the server system, cause the server system to perform the above method.

### BRIEF DESCRIPTION OF THE DRAWINGS

For a better understanding of the various described embodiments, reference should be made to the Description of Embodiments below, in conjunction with the following drawings. Like reference numerals refer to corresponding parts throughout the figures and description.

FIG. 1 is a block diagram illustrating a network architecture for verifying a user login with an application, in accordance with some embodiments.

FIG. 2 is a block diagram illustrating a user device, in accordance with some embodiments.

FIG. 3 is a block diagram illustrating an account server system, in accordance with some embodiments.

FIG. 4 is a block diagram illustrating a social networking system, in accordance with some embodiments.

FIG. 5A is a flow diagram illustrating a method for verifying a user login at an account server system, in accordance with some embodiments.

FIG. 5B is a block diagram illustrating a method for verifying a user login at a social networking system, in accordance with some embodiments.

### DESCRIPTION OF EMBODIMENTS

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first item could be termed a second item, and, similarly, a second item could be termed a first item, without departing from the scope of the various described embodiments. The first item and the second item are both items, but they are not the same item.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

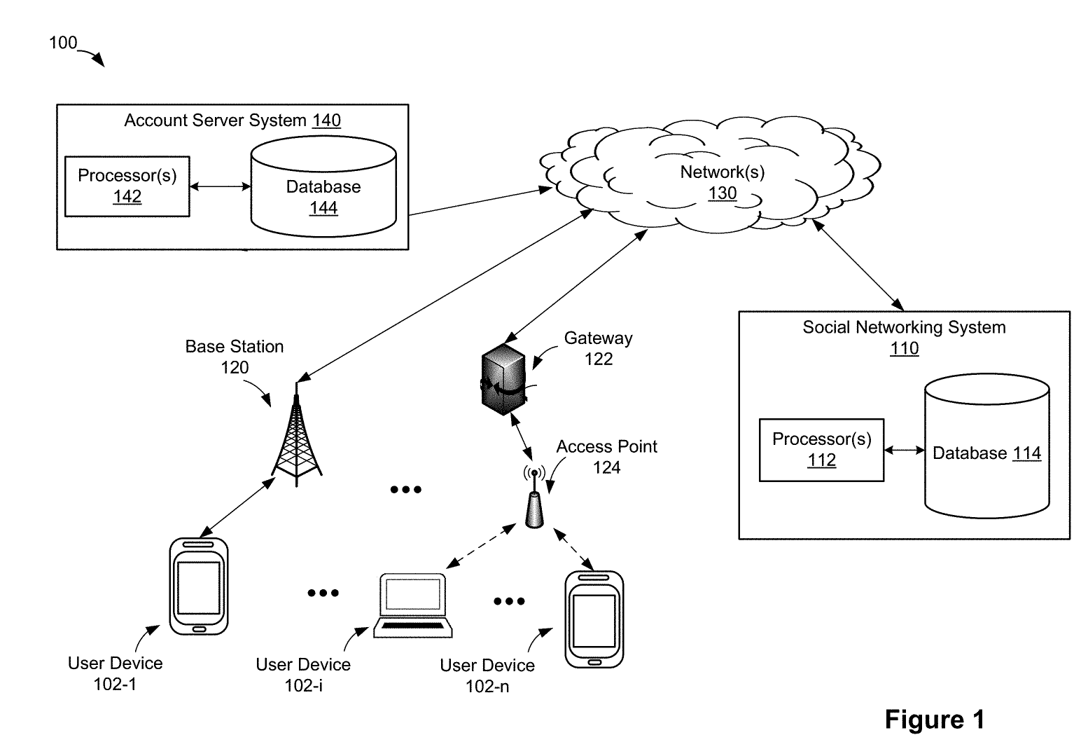

FIG. 1 is a block diagram illustrating a network architecture for verifying a user login with an application, in accordance with some embodiments. The network architecture 100 allows mobile carriers (and/or network providers) to provide Internet service to one or more users. The network architecture 100 routes the traffic from one or more user devices 102 to destination IP addresses. The network architecture 100 thus provides various products and/or functionalities to the users.

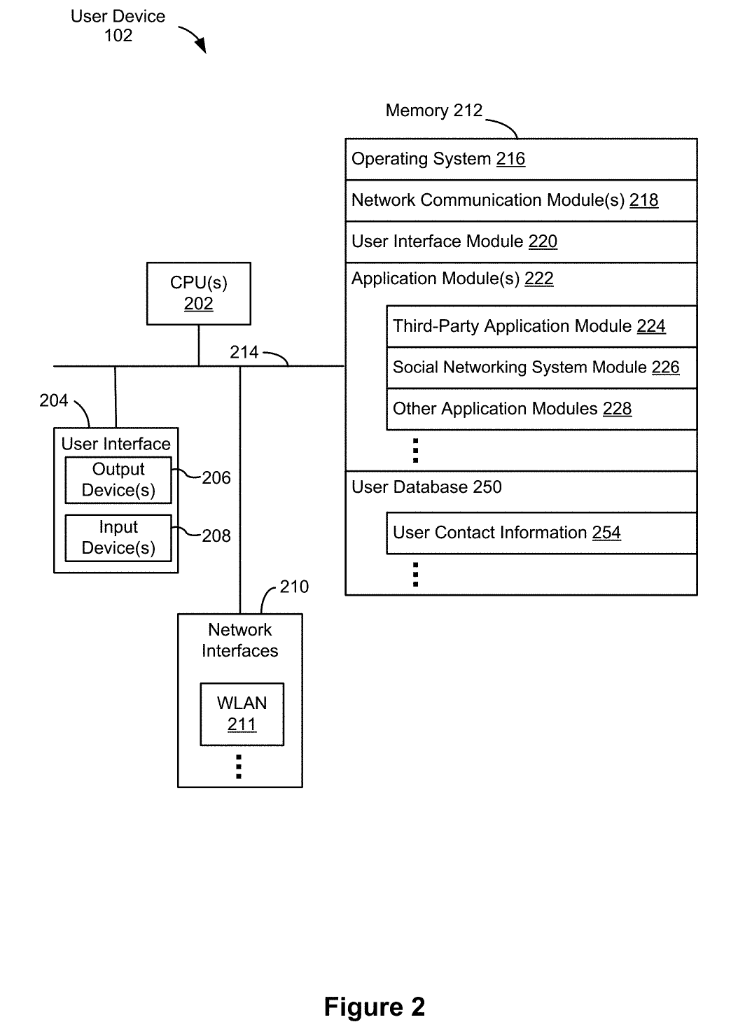

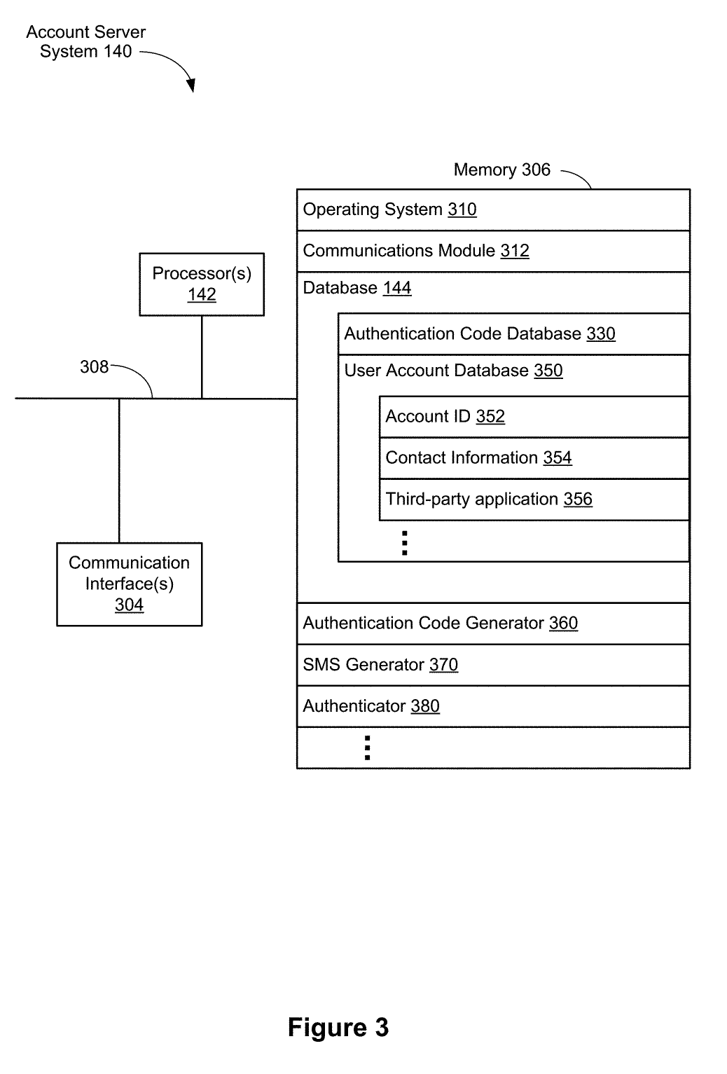

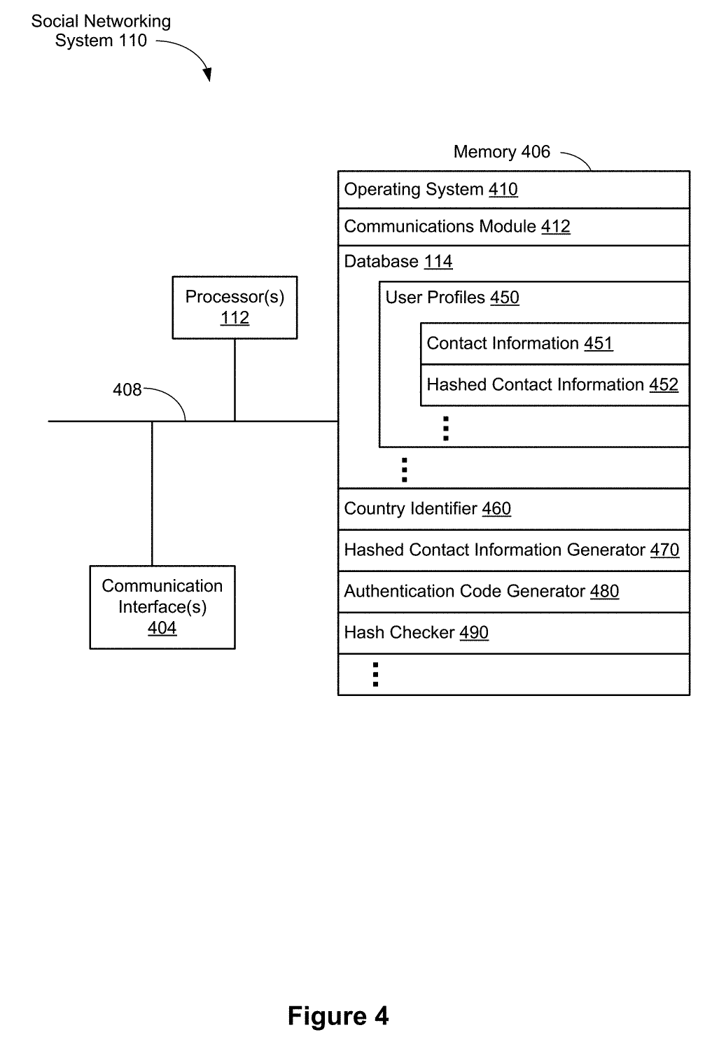

The network architecture 100 includes client-side modules (e.g., as discussed with reference to FIG. 2) executed on a number of user devices (also called “client devices,” “client systems,” “client computers,” “subscriber devices” or “clients”) 102-1, 102-2 . . . 102-n, and server-side modules (e.g., as discussed with reference to FIGS. 3 and 4) executed on one or more server systems, such as a social networking system 110 and an account server system 140. The user devices 102 communicate with the server systems (e.g., the social networking system 110 and the account server system 140) through one or more networks 130 (e.g., the Internet, cellular telephone networks, mobile data networks, other wide area networks, local area networks, metropolitan area networks, and so on). Client-side modules provide client-side functionalities for the network service platform (e.g., Internet service) and communications with server-side modules. As discussed in more detail below, the client-side modules may include various third-party applications that may require user verification. Server-side modules provide server-side functionalities for the network service platform (e.g., routing network traffic, verifying user login information, contacting user devices using contact information, providing a social networking platform, etc.) for any number of user devices 102.

In some embodiments, the user devices 102 are mobile devices and/or fixed-location devices. The user devices 102 are associated with users (e.g., subscribers) who employ the user devices 102 to access one or more IP addresses. The user devices 102 execute web browser applications and/or other applications that can be used to access the one or more IP addresses.

Examples of the user devices 102 include, but are not limited to, feature phones, smart phones, other mobile phones, smart watches, personal digital assistants, portable media players, tablet computers, 2D and 3D gaming devices, virtual reality devices, laptop computers, desktop computers, televisions with one or more processors embedded therein or coupled thereto, in-vehicle information systems (e.g., an in-car computer system that provides navigation, entertainment, and/or other information), wearable computing devices, personal digital assistants (PDAs), enhanced general packet radio service (EGPRS) mobile phones, media players, navigation devices, game consoles, smart televisions, remote controls, combinations of any two or more of these data processing devices or other data processing devices, and/or other appropriate computing devices that can be used to communicate with the proxy server 110 and the remote server 140.

In some embodiments, the network architecture 100 includes one or more base stations 120 for carrier networks that provide cellular service to the user devices 102. One or more network operators (e.g., network service providers, network carriers, or cellular companies) own or control the one or more base stations 120 and related infrastructure. For example, the base station 120 communicably connects one or more user devices 102 (e.g., 102-1) to one another and/or to the networks 130. In some embodiments, the network architecture 100 includes one or more gateways 122 connected to one or more wireless access points 124 respectively for providing Wi-Fi networks to the user devices 102 (e.g., 102-i, 102-n). The base stations 120 and the gateways 122 are responsible for routing traffic between the networks 130 and the user devices 102.

The account server system 140 is implemented on one or more standalone computers or a distributed network of computers. In some embodiments, the account server system 140 also employs various virtual devices and/or services of third party service providers (e.g., cloud computing) to provide the underlying computing resources and/or infrastructure resources of the account server system 140. The account server system 140 includes one or more processors/cores 142 and one or more databases 144. The one or more processors/cores 142 process requests for respective network services from the user devices 102, and provide responses including requested user verification to applications executed on the user devices 102. The database 144 stores various information, including but not limited to authentication codes and user accounts that correlate account IDs with contact information and third-party applications.

Users may employ the user devices 102 to access the social networking system 110 and to participate in a corresponding social networking service. For example, one or more of the user devices 102-1, 102-i, . . . 102-n execute web browser applications that can be used to access the social networking system 110. As another example, one or more of the user devices 102-1, 102-i, . . . 102-n execute software applications that are specific to the social networking system 110 (e.g., social networking “apps” running on smart phones or tablets, such as a Facebook social networking application, a messaging application, etc., running on an iPhone, Android, or Windows smart phone or tablet).

Users interacting with the user devices 102-1, 102-i, . . . 102-n can participate in the social networking service provided by the social networking system 110 by providing and/or consuming (e.g., posting, writing, viewing, publishing, broadcasting, promoting, recommending, sharing) information, such as text comments (e.g., statuses, updates, announcements, replies, location “check-ins,” private/group messages), digital content (e.g., photos (i.e., images), videos, audio files, links, documents), and/or other electronic content. In some embodiments, users provide information to a page, group, message board, feed, and/or user profile of a social networking service provided by the social networking system 110. Users of the social networking service can also annotate information posted by other users of the social networking service (e.g., endorsing, “liking,” or otherwise responding or reacting to a posting of another user, commenting on a posting by another user, or sharing a posting of another user).

In some embodiments, information can be posted on a user's behalf by systems and/or services external to the social networking system 110. For example, the user may post a review of a movie to a movie review website, and with proper permissions that website may cross-post the review to the social networking service on the user's behalf. In another example, a software application executing on a mobile client device, with proper permissions, may use a global navigation satellite system (GNSS) (e.g., global positioning system (GPS), GLONASS, etc.) or other geo-location capabilities (e.g., Wi-Fi or hybrid positioning systems) to determine the user's location and update the social networking service with the user's location (e.g., “At Home,” “At Work,” or “In San Francisco, Calif.”), and/or update the social networking service with information derived from and/or based on the user's location. Users interacting with the user devices 102-1, 102-i, . . . 102-n can also use the social networking service provided by the social networking system 110 to define groups of users. Users interacting with the user devices 102-1, 102-i, . . . 102-n can also use the social networking service provided by the social networking system 110 to communicate (e.g., using a messaging application or built-in feature) and collaborate with each other.

The social networking system 110 includes one or more processors/cores 112 and one or more databases 114. The database 114 is used for storing user profiles, as well as various information relating to user contact information and authentication to be utilized in conjunction with user devices 102 and account server system 140.

FIG. 2 is a block diagram illustrating an exemplary user device 102 (e.g., one of the user devices 102-1 through 102-n of FIG. 1) in accordance with some embodiments. The user device 102 typically includes one or more central processing units (CPU(s)) (e.g., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

The user device 102 includes a user interface 204, including output device(s) 206 and input device(s) 208. In some embodiments, the input devices include a keyboard or a track pad. Alternatively, or in addition, the user interface 204 includes a display device that includes a touch-sensitive surface, in which case the display device is a touch-sensitive display. In user devices that have a touch-sensitive display, a physical keyboard is optional (e.g., a soft keyboard may be displayed when keyboard entry is needed). The output devices 206 also optionally include speakers and/or an audio output connection (i.e., audio jack) connected to speakers, earphones, or headphones. Optionally, the user device 102 includes an audio input device (e.g., a microphone) to capture audio (e.g., speech from a user). Furthermore, some user devices 102 use a microphone and voice recognition software to supplement or replace the keyboard. Optionally, the user device 102 includes a location-detection device, such as a global-navigation-satellite-system (GNSS) receiver (e.g., a GPS (global positioning system), GLONASS, or other geo-location receiver), and/or location-detection software for determining the location of the user device 102.

In some embodiments, the one or more network interfaces 210 include wireless and/or wired interfaces for receiving data from and/or transmitting data to other user devices 102, the social networking system 110, the account server system 140, and/or other devices or systems. In some embodiments, data communications are carried out using any of a variety of custom or standard wireless protocols (e.g., cellular protocols, NFC, RFID, IEEE 802.15.4, IEEE 802.11/Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, in some embodiments, the one or more network interfaces 210 include a wireless LAN (WLAN) interface 211 for enabling data communications with other WLAN-compatible devices (via the one or more network(s) 130, FIG. 1).

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware dependent tasks;
network communication module(s) 218 for connecting the user device 102 to other computing devices (e.g., the social networking system 110, the account server system 140, other user devices 102, and/or other devices) via the one or more network interface(s) 210 (wired or wireless);
a user interface module 220 that receives commands and/or inputs from a user via the user interface 204 (e.g., from the input devices 208, which may include keyboards, touch screens, microphones, eye tracking components, three-dimensional gesture tracking components, and the like), and provides user interface objects and other outputs for display on the user interface 204 (e.g., the output devices 206, which may include a display screen, a touchscreen, a speaker, etc.);
one or more client application modules 222, some of which may require user verification, and including the following modules (or sets of instructions), or a subset or superset thereof:
   third-party application modules 224 (e.g., “third-party applications”), such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support;
   a social networking system module 226 for providing an interface to the social networking system 110 and related features; and
   other optional client application modules 228 (e.g., “third-party applications”), such as a web browser (e.g., Internet Explorer or Edge by Microsoft, Firefox by Mozilla, Safari by Apple, Opera by Opera Software, or Chrome by Google) for accessing, viewing, and interacting with web sites;
user database 250 for storing entered contact information associated with a user, including, but not limited to phone number(s), email addresses, and/or instant messaging (“TM”) addresses.

Each of the above-identified modules and applications corresponds to a set of executable instructions for performing one or more functions as described above and/or in the methods described herein (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments.

FIG. 3 is a block diagram illustrating an exemplary account server system 140 in accordance with some embodiments. The account server system 140 includes one or more processing units (processors or cores) 142, one or more network or other communications interfaces 304, memory 306, and one or more communication buses 308 for interconnecting these components. The communication buses 308 optionally include circuitry (sometimes called a chipset) that interconnects and controls communications between system components. The account server system 140 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

Memory 306 includes high-speed random-access memory, such as DRAM, SRAM, DDR RAM, or other random-access solid-state memory devices, and may include non-volatile memory, such as one or more magnetic disk storage devices, optical disk storage devices, flash memory devices, and/or other non-volatile solid-state storage devices. Memory 306 may optionally include one or more storage devices remotely located from the processor(s) 142. Memory 306, or alternately the non-volatile memory device(s) within memory 306, includes a non-transitory computer-readable storage medium. In some embodiments, memory 306 or the computer-readable storage medium of memory 306 stores the following programs, modules and data structures, or a subset or superset thereof:
an operating system 310 that includes procedures for handling various basic system services and for performing hardware dependent tasks;
a communications module 312 that is used for connecting the account server system 140 to other computers via the one or more communication network interfaces 304 (wired or wireless) and one or more communication networks (e.g., the one or more networks 130) and for sending and receiving short message service (“SMS”) messages to various devices such as user devices 102;
a database 144 for storing data associated with user authentication and user accounts, which includes:
   authentication code database 330 for storing codes generated by authentication code generator 360 and associated with requests from user devices 102 for verifying users;
   user account database 350 to store an account ID 352 to be associated with a user's contact information 354 and a third-party application 356 (e.g., the third-party application 356's ID)
an authentication code generator 360 for generating authentication codes to be used in user verification on user devices 102, where the authentication code may be a randomly generated sequence of text, numbers, and/or symbols;
SMS generator 370 for generating SMS messages including an authentication code generated by authentication code generator 360 to be sent to contact information provided for a user by user device 102; and
authenticator 380 for determining whether a code entered by a user on a user device 102 matches the authentication code sent to the contact information associated with that user, using authentication code database 330, and thereby determining whether to verify the user to an application executed on the same or another user device 102.

As described above, contact information 354 may include a phone number, email address, and/or IM address of a user. In some embodiments, the memory 306 may additionally include an email generator for generating an email message including an authentication code generated by authentication code generator 360, to be sent to contact information for a user by user device 102, to be used when the contact information includes an email address.

FIG. 4 is a block diagram illustrating an exemplary social networking system 110 in accordance with some embodiments. The social networking system 110 includes one or more processing units (processors or cores) 112, one or more network or other communications interfaces 404, memory 406, and one or more communication buses 408 for interconnecting these components. The communication buses 408 optionally include circuitry (sometimes called a chipset) that interconnects and controls communications between system components. The social networking system 110 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

Memory 406 includes high-speed random-access memory, such as DRAM, SRAM, DDR RAM, or other random-access solid-state memory devices, and may include non-volatile memory, such as one or more magnetic disk storage devices, optical disk storage devices, flash memory devices, and/or other non-volatile solid-state storage devices. Memory 406 may optionally include one or more storage devices remotely located from the processor(s) 112. Memory 406, or alternately the non-volatile memory device(s) within memory 406, includes a non-transitory computer-readable storage medium. In some embodiments, memory 406 or the computer-readable storage medium of memory 406 stores the following programs, modules and data structures, or a subset or superset thereof:
an operating system 410 that includes procedures for handling various basic system services and for performing hardware dependent tasks;
a network communications module 412 that is used for connecting the social networking system 110 to other computers via the one or more network communication interfaces 404 (wired or wireless) and one or more communication networks (e.g., the one or more networks 130);
a database 114 for storing user profiles 450 for each user, the user profiles 450 including:
   contact information 451, including, but not limited to, a phone number, an email address, and/or an IM address; and
   hashed contact information 452, including contact information 451 that has been hashed by hashed contact information generator 470 and stored in correlation with contact information 451;
country identifier 460 for identifying the country of a user requesting verification with a third-party application on a user device 102 based on entered contact information, where the country identification may be based on an Internet Protocol (“IP”) address of the user device 102;
hashed contact information generator 470 for generating two hash values of contact information when the contact information is a phone number, one of the hash values being generated directly from the phone number and the other hash value being generated based on the hashed phone number prepended with a hashed country code, the country code being determined based on a country of the user as identified by country identifier 460, where the hash values may be generated using any suitable hash function as known in the art, encryption, or checksums;
authentication code generator 480 for generating an authentication code to be sent to a user profile using, e.g., a user notification in the social networking system, or, alternatively, to provide the authentication code generated by authentication code generator 360 of account server system 140 as the authentication code to be sent to the user profile; and
hash checker 490 for comparing one or two hash values of contact information generated by hashed contact information generator 470 with the hashed contact information 452 stored in database 114, and identifying a match.

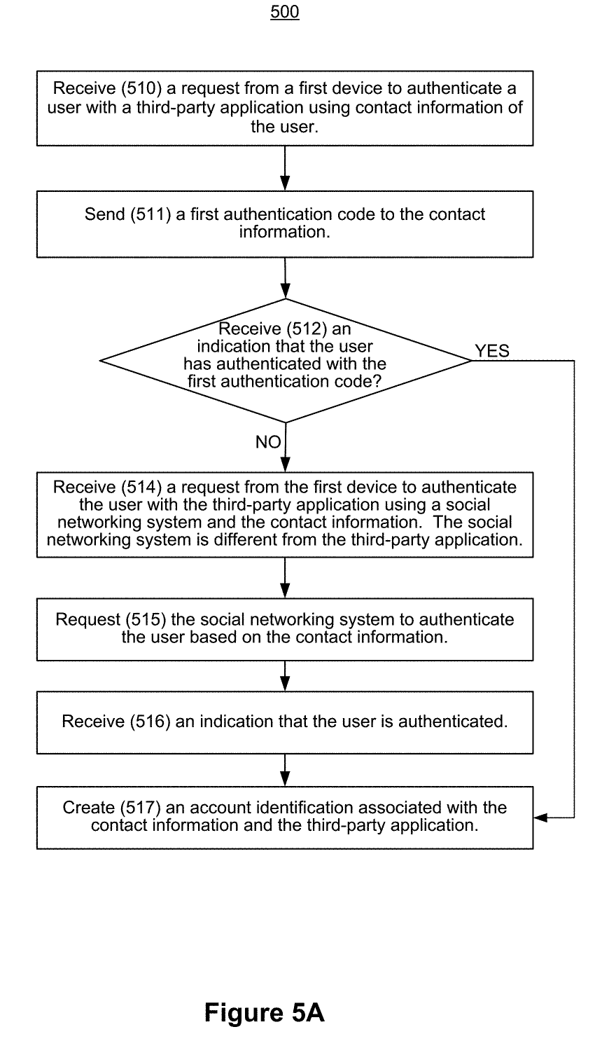

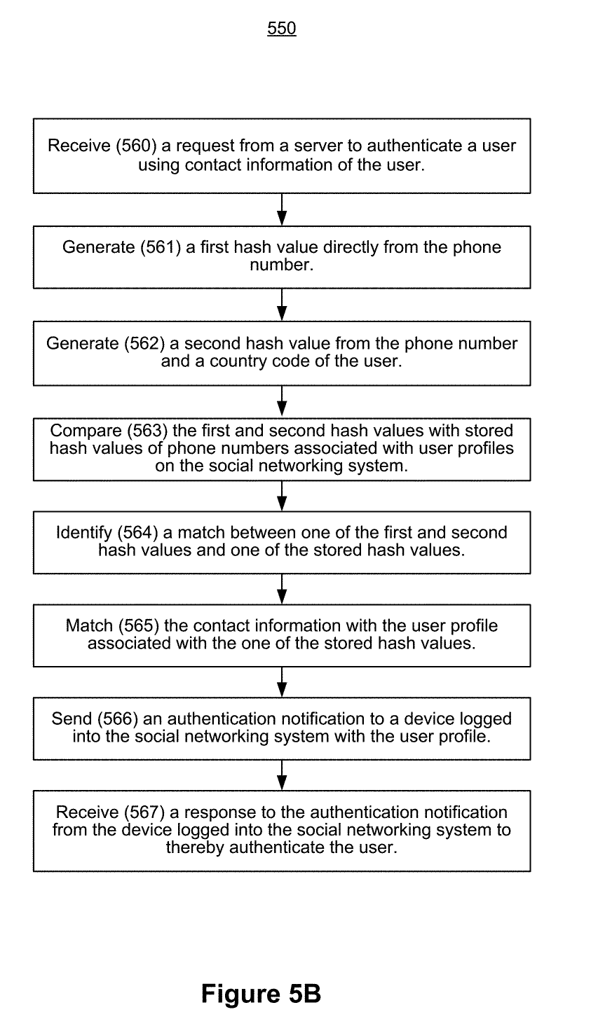

FIG. 5A is a flow diagram illustrating a method 500 for verifying a user login to a third-party application using contact information, in accordance with some embodiments. The method 500 is performed by a server system (e.g., account server system 140, FIGS. 1 and 3). Operations performed in FIG. 5A correspond to instructions stored in computer memories (e.g., memories 306, FIG. 3) or other computer-readable storage mediums. In some embodiments, the first device described in method 500 is any user device 102 (FIGS. 1-2). In some embodiments, the social networking system described in method 500 is the social networking system 110 (FIGS. 1 and 4).

With reference to FIG. 5A, in some embodiments, the server system (e.g., account server system 140, FIGS. 1 and 3) receives (510) a request from a first device (e.g., a user device 102 shown in FIGS. 1-2) to authenticate a user of the first device with a third-party application (e.g., a third-party application module 224, FIG. 2) using contact information of the user. The contact information may be provided to the third-party application by the user on the first device. For example, the user may be prompted to enter a phone number for logging into the third-party application on the first device. The third-party application on the first device may then operate to send the request to the account server system 140 over, e.g., network 130. In some embodiments, the contact information is a telephone number of the user, although embodiments are not limited thereto, and in other examples, the contact information may be an email address.

In some embodiments, after the server system 140 receives the request from the first device, the server system 140 may generate (e.g., by using authentication code generator 360, FIG. 3) a first authentication code to be sent to the contact information of the user. The first authentication code may, for example, be a randomly generated sequence of text, numbers, and/or symbols, or any other manner of code that may be received and entered by the user at a device (e.g., one of the user devices 102, FIGS. 1-2) associated with the contact information. Additionally, in some embodiments, the server system 140 may store (e.g., in authentication code database 330) the first authentication code in correlation with the request.

After generating the first authentication code, the server system 140 may generate a message to be sent to the contact information. For example, in some embodiments, server system 140 may generate a Short Message Service (“SMS”) message (e.g., using SMS generator 370, FIG. 3). This message may include the first authentication code. The server system 140 may then send (511) the message including the first authentication code to the contact information. For example, in an embodiment where the server system 140 generates an SMS message, the server system 140 may send the SMS message to the contact information (e.g., the user's phone number) over network 130. In an example embodiment, the first authentication code may expire and be unable to be used to authenticate after a certain amount of time. For example, the first authentication code may expire 10 minutes after the server system sends the message to the contact information.

In some examples, the contact information (e.g., the user's phone number) may be associated with the first device. However, embodiments are not limited thereto, and in other examples, the contact information may be associated with another of user devices 102 (FIGS. 1-2). For example, the contact information may be a phone number belonging to a user device 102 different from the first device.

The user may thus receive the message (e.g., SMS message) including the first authentication code on a user device 102 associated with the contact information (e.g., the user's phone number). At this time, the user may enter the first authentication code on the first device. For example, the user may enter the first authentication code into the third-party application.

The first device may then send the entered code to the server system 140 (e.g., account server system 140, FIGS. 1 and 3), which may verify (e.g., using authenticator 380, FIG. 3) whether or not the entered code matches the first authentication code sent to the contact information. For example, the server system 140 may match the entered code with the first authentication code stored in authentication code database 330. If the codes match, the server system 140 may treat this as receipt (512) of an indication that the user has successfully authenticated with the first authentication code, and send indication to the third-party application running on the first device that the user is allowed to login. Alternatively, if the codes do not match, the server system 140 may send indication to the third-party application that the user's login should be declined.

In an example where the server system 140 has received (512) an indication that the user has authenticated with the first authentication code, the server system 140 may proceed to create (517) an account identification (e.g., “account ID” 352, FIG. 3) associated with the contact information (e.g., contact information 354, FIG. 3) and third-party application (e.g., third-party application 356, FIG. 3). However, embodiments are not limited thereto, and in another example, the server system 140 may create the account ID associated with the contact information prior to receiving (512) an indication that the user has authenticated with the first authentication code, and may activate the account ID after receiving (512) such an indication. This account ID may be assigned to the user by the server system 140 regardless of which user device 102 the user uses to run the third-party application. Thus, in an example where the user installs the third-party application on a user device 102, and has already verified with the third-party application on another user device 102 (e.g., the first device) using his or her contact information, the user may enter the contact information on this new user device 102, and after verifying the user, the server system 140 may inform the third-party application on the new user device 102 that the user has the same account ID as on another device, and is therefore the same user.

However, messaging systems are not necessarily 100% reliable, and in some examples, the message including the first authentication code and sent (511) by the server system 140 to the contact information may not reach the contact information. For example, an SMS message may fail to reach the provided phone number. In such examples, where the server system 140 fails to receive (512) an indication that the user has authenticated with the first authentication code, the user may still desire to be able to verify with the third-party application without providing complete login information to the third-party application.

Thus, in some embodiments, when the server system 140 fails to receive (512) an indication that the user has authenticated with the first authentication code, the user on the first device (e.g., a user device 102) may opt for the server system 140 to resend an authentication code (which may be the same or different from the first authentication code). Alternatively, the third-party application may provide the user with the option to authenticate using, e.g., a notification accessed through a social networking system (e.g., social networking system 110, FIGS. 1 and 4).

Thus, if the user selects this option, the server system 140 may receive (514) a request from the first device to verify the user with the third-party application using the social networking system and the contact information. As with the authentication using messaging, only the user's contact information may need to be provided to the server system 140 in order for authentication to take place. In some embodiments, the social networking system is different from the third-party application, and the third-party application does not interface or otherwise interact with the social networking system.

In some embodiments, the server system 140 may thereafter send a request (515) over network 130 to the social networking system 110 to authenticate the user based on the contact information. In some examples, this request may include the first authentication code or another authentication code generated by authentication code generator 360, although embodiments are not limited thereto. The request may also include an Internet Protocol (“IP”) address associated with the first device.

In some embodiments, the server system 140 may receive (516) an indication that the user is authenticated and, in an example, proceed with verifying the user's login to the third-party application on the first device. This indication may be received from the social networking system 110. Alternatively, this indication may be received in the form of an authentication code sent from the first device that, in one example, matches an authentication code received from the social networking system 110 or that, in another example, matches the first authentication code or another authentication code sent to the social networking system 110 by the server system 140. The authentication performed by social networking system 110 will be described below with reference to FIG. 5B.

In some embodiments, after receiving (516) an indication that the user is authenticated, the server system 140 may create (517) an account ID associated with the contact information and the third-party application, as described above. However, embodiments are not limited thereto, and in another example, the server system 140 may create the account ID associated with the contact information prior to receiving (516) an indication that the user is authenticated, and may activate the account ID after receiving (516) such an indication.

FIG. 5B is a flow diagram illustrating a method 550 for verifying a user login to a third-party application using contact information, in accordance with some embodiments. The method 550 is performed by a social networking system (e.g., social networking system 110, FIGS. 1 and 4). Operations performed in FIG. 5B correspond to instructions stored in computer memories (e.g., memories 406, FIG. 4) or other computer-readable storage mediums. In some embodiments, the server described in method 550 is the account server system 140.

With reference to FIG. 5B, in some embodiments, social networking system 110 may receive (560) a request from server system 140 to authenticate a user using the contact information of the user. The contact information may be the same as that provided to the server system 140 in the method described for FIG. 5A, and may, for example, be the phone number entered by the user at the first device.

In some embodiments, the social networking system 110 may generate (e.g., using hashed contact information generator 470) a first hash value directly from the phone number. Furthermore, the social networking system may generate a second hash value from the phone number and a country code of the user. To generate this second hash value, the social networking system 110 may first determine a country of the user (e.g., using country identifier 460). In an example embodiment, this determination may be made based on the IP address of the first device, as provided by the server system 140, but embodiments are not limited thereto.

In some embodiments, once the country of the user is identified, the hashed contact information generator 470 may generate (562) the second hash value based on the phone number and the country code for the user's identified country. For example, this second hash value may be a concatenation of a hash of the country code and a hash of the phone number.

In some embodiments, the social networking system 110 may compare (563) (e.g., using hash checker 490, FIG. 4) the first and second hash values with stored hash values of phone numbers associated with user profiles of the social networking system 110. However, in some embodiments, where the phone number provided by the server system 140 is known to already include or not include the country code, the social networking system 110 may only compare one of the first and second hash values with the stored hash values. For example, when the phone number is known to include the country code, the social networking system 110 may only compare the first hash value with the stored hash values.

With regard to the stored hash values that the social networking system 110 compares the first and second hash values against, in some embodiments, these stored hash values may be pre-stored as hashed contact information (e.g., hashed contact information 452, FIG. 4) in correlation with user contact information 451 (e.g., contact information 451, FIG. 4) in, for example, memory 406. For example, once a day or at another periodic interval, the social networking system may generate two hash values of each phone number for all user profiles stored in the social networking system database (e.g., database 114, FIG. 4). One of the values may be generated directly from the user's phone number, and the other value may be generated as a concatenation of a hash of the user's country code and a hash of the user's phone number. The country identifier 460 may identify the country associated with the user's phone number based on the user's location identified from the user's profile in the social networking system 110 (e.g., one of the user profiles 450, FIG. 4), account activity locations (e.g., again determined through IP address), and/or other location information retrieved from the user's profile 450.

In some embodiments, after identifying (564) a match between one of the first and second hash values and one of the stored hash values (e.g., one of the values of hashed contact information 452, FIG. 4), the social networking system matches (565) the contact information (e.g., contact information 451, FIG. 4) correlated with the hashed contact information 452 to a user profile (e.g., one of the user profiles 450, FIG. 4).

In some embodiments, the social networking system 110 may send (566) a notification to a second device (e.g., one of the user devices 102, FIGS. 1-2) logged into the social networking system 110 with the user profile. In an example embodiment, the second device logged into the social networking system 110 may be different from the first device, but embodiments are not limited thereto, and in other examples, the second device and the first device may be the same user device 102.

The notification may be a notification to authenticate a login to the third-party application on the first device, and may include a message. The message may include a hyperlink or an authentication code. In an embodiment where the message includes a hyperlink, navigating to the hyperlink on the second device logged into the social networking system 110 may serve as confirmation to the social networking system 110 that the user authenticates the login to the third-party application at the first device. In other examples, the user may respond to the notification message on the second device in whatever manner desirable for authenticating the user. The social networking system 110 may treat these actions as receipt (567) of a response to the authentication notification that thereby authenticates the user, and informs the server system 140 accordingly such that the server system 140 receives (e.g., step 516, FIG. 5A) an indication from the social networking system 110 that the user is authenticated, as described above.

Alternatively, in an embodiment where the message includes an authentication code, this authentication code may be the first authentication code or another authentication code provided to the social networking system 110 from server system 140, as described above, or it may be an authentication code generated by the social networking system 110 itself (e.g., using authentication code generator 480). In an embodiment where the social networking system 110 generates the authentication code, this authentication code may be sent back to server system 140 for authentication. The user may be prompted to enter this authentication code at the first device, in which case the server system 110 may receive the authentication code from the first device, or the user may enter the code as a response to the notification message on the second device logged into the social networking system 110. In either case, server system 140 may treat successful authentication as receipt (516) of an indication (directly or indirectly) from the social networking system 110 that the user is authenticated, as described above.

Although some of various drawings illustrate a number of logical stages in a particular order, stages which are not order dependent may be reordered and other stages may be combined or broken out. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method, comprising:
at a server system having one or more processors and memory storing instructions for execution by the one or more processors:
receiving, from a first device, a request to authenticate a user with a third-party application using a social networking system and contact information of the user; and
requesting the social networking system to authenticate the user based on the contact information,
wherein the social networking system is different from the third-party application.

2. The method of claim 1, further comprising, at the server system:
sending a first authentication code to the contact information prior to receiving, from the first device, the request to authenticate the user with the third-party application using the social networking system.

3. The method of claim 1, wherein the contact information is an email address.

4. The method of claim 2, wherein the contact information is a phone number.

5. The method of claim 4, wherein sending the first authentication code to the contact information comprises:
sending a short message service (SMS) message to the phone number, the SMS message including the first authentication code.

6. The method of claim 2, wherein the first authentication code is a randomly generated sequence of text symbols.

7. The method of claim 1, wherein requesting the social networking system to authenticate the user based on the contact information comprises:
sending a request to authenticate the user to the social networking system, the request including the contact information of the user;
receiving, at the social networking system, the request to authenticate the user;
matching the contact information with a user profile of the social networking system; and
sending an authentication notification to a device logged into the social networking system with the user profile.

8. The method of claim 7, wherein the contact information is a phone number, and matching the contact information with the user profile of the social networking system comprises:
generating two hash values of the phone number, one of the hash values being generated directly from the phone number, and the other of the hash values being generated from the phone number and a country code of the user;
comparing the two hash values with stored hash values of phone numbers associated with user profiles on the social networking system;
identifying a match between one of the two hash values and one of the stored hash values; and
matching the contact information with the user profile associated with the one of the stored hash values.

9. The method of claim 8, further comprising:
determining the country code of the user based on an internet protocol (IP) address of the user.

10. The method of claim 7, wherein the authentication notification includes an authentication code, and the method further comprises:
receiving, from the first device, the authentication code to thereby authenticate the user.

11. The method of claim 10, further comprising:
sending a first authentication code to the contact information prior to receiving, from the first device, the request to authenticate the user with the third-party application using the social networking system,
wherein the authentication code included in the authentication notification is the first authentication code or another authentication code.

12. The method of claim 7, wherein the authentication notification includes a hyperlink, and the method further comprises:
receiving an indication that the user has navigated to the hyperlink.

13. The method of claim 7, wherein the method further comprises:
receiving, from the device logged into the social networking system, a response to the authentication notification to thereby authenticate the user.

14. The method of claim 1, further comprising:
receiving an indication that the user is authenticated; and
after the user is authenticated, creating, by the server system, an account identification associated with the contact information and the third-party application.

15. A non-transitory computer-readable storage medium storing one or more programs for execution by one or more processors of a server system, the one or more programs including instructions for:
receiving, from a first device, a request to authenticate a user with a third-party application using a social networking system and contact information of the user; and
requesting the social networking system to authenticate the user based on the contact information,
wherein the social networking system is different from the third-party application.

16. A server system, comprising:
one or more processors; and
memory storing one or more programs for execution by the one or more processors, the one or more programs including instructions for:
receiving, from a first device, a request to authenticate a user with a third-party application using a social networking system and contact information of the user; and
requesting the social networking system to authenticate the user based on the contact information,
wherein the social networking system is different from the third-party application.
